(19) United States
(12) Patent Application Publication
(10) Pub. No.: US 2023/0267489 A1
(43) Pub. Date: Aug. 24, 2023

(54) MOVING BODY MANAGEMENT SYSTEM AND CONTROL METHOD FOR MOVING BODY MANAGEMENT SYSTEM

(71) Applicant: HONDA MOTOR CO., LTD., Tokyo (JP)

(72) Inventors: Noriyuki Ishida, Wako-shi (JP); Satoshi Suda, Wako-shi (JP)

(21) Appl. No.: 18/160,598

(22) Filed: Jan. 27, 2023

(30) Foreign Application Priority Data
Feb. 22, 2022 (JP) 2022-025914

(51) Int. Cl. G06Q 30/0207; G06Q 30/0645; G06Q 10/0631; G06Q 50/30

(52) U.S. Cl. CPC G06Q 30/0207; G06Q 30/0645; G06Q 10/06315; G06Q 50/30

(57) ABSTRACT

The moving body management system includes a first detecting unit that detects a ridable electric scooter that is abandoned for a predetermined period or longer at a location that is not a predetermined location, a second detecting unit that detects a vehicle approaching an abandonment area including a current position of the electric scooter detected by the first detecting unit based on information on the current position of the electric scooter detected by the first detecting unit, and a calculating unit that, if a user of the vehicle detected by the second detecting unit moves the electric scooter to the predetermined location, calculates an incentive to be given to the user of the vehicle detected by the second detecting unit.

### INCORPORATION BY REFERENCE

The present application claims priority under 35 U.S.C. § 119 to Japanese Patent Application No. 2022-025914 filed on Feb. 22, 2022. The content of the application is incorporated herein by reference in its entirety.

### BACKGROUND OF THE INVENTION

### Field of the Invention

The present invention relates to a moving body management system and a control method for the moving body management system.

### Description of the Related Art

Conventionally, a technology has been known that reduces the number of moving bodies that have been abandoned. For example, Japanese Patent Laid-Open No. 2020-016668 discloses a navigation system that searches a candidate route including a route to be used by a rental cycle which is detected as an abandoned vehicle and outputs the searched candidate route.

### SUMMARY OF THE INVENTION

Although the method disclosed in Japanese Patent Laid-Open No. 2020-016668 can recognize a route on which a user of a terminal apparatus uses an abandoned vehicle, whether the abandoned vehicle is to be used or not is determined by the user of the terminal apparatus. For that, since the degree of reduction of the number of abandoned vehicles depends on the user determination in the method disclosed in Japanese Patent Laid-Open No. 2020-016668, there is a possibility that the number of abandoned vehicles is not effectively reduced.

The present invention was made in view of the circumstances described above, and it is an object of the present invention to provide a moving body management system and a control method for the moving body management system, which can effectively reduce the number of moving bodies that have been abandoned.

One aspect for achieving the object is a moving body management system including a first detecting unit that detects a ridable moving body that is abandoned for a predetermined period or longer at a location that is not a predetermined location, a second detecting unit that detects a vehicle approaching an abandonment area including a current position of the moving body detected by the first detecting unit based on information on the current position of the moving body detected by the first detecting unit, and a calculating unit that, if a user of the vehicle detected by the second detecting unit moves the moving body to the predetermined location, calculates an incentive to be given to the user of the vehicle detected by the second detecting unit.

According to the present invention, the number of moving bodies that have been abandoned can be effectively reduced.

### BRIEF DESCRIPTION OF THE DRAWINGS

FIG. 1 is a diagram showing an overview of a moving body management system;

FIG. 2 is a diagram showing configurations of an electric scooter, a vehicle and a terminal apparatus;

FIG. 3 is a diagram showing a configuration of a server apparatus;

FIG. 4 is a flowchart showing operations of the moving body management system;

FIG. 5 is a flowchart showing operations of a first determining unit; and

FIG. 6 is a flowchart showing operations of the moving body management system.

### DETAILED DESCRIPTION OF THE PREFERRED EMBODIMENTS

### [1. Overview of Moving Body Management System]

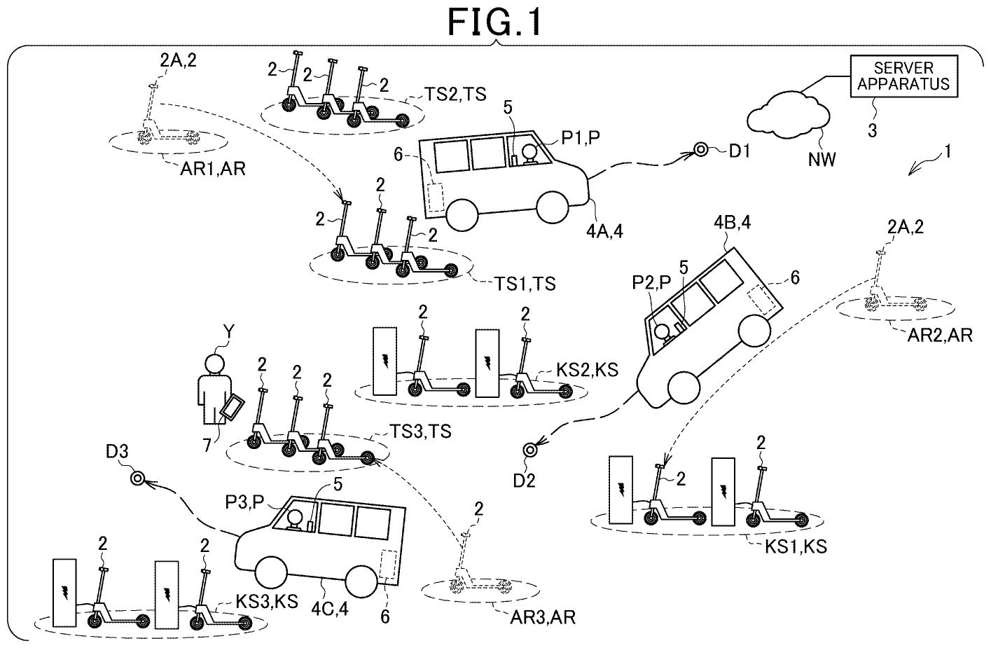

With reference to FIG. 1, an overview of a moving body management system 1 according to an embodiment is described.

FIG. 1 is a diagram showing an overview of the moving body management system 1.

The moving body management system 1 according to this embodiment is a system that manages an electric scooter 2 that is one example of a moving body. More specifically, the moving body management system 1 manages a current position of the electric scooter 2, an amount of charge of a moving body battery 23 that is a driving source of the electric scooter 2, and so on. The electric scooter 2 is a vehicle that runs with an electric drive motor 24 attached to the scooter. The electric scooter 2 may be of a stand-riding type or a sit-riding type.

The electric scooter 2 according to this embodiment is a rental vehicle that is lent to a person who uses the electric scooter 2.

The moving body battery 23 corresponds to a “first charging apparatus” of the present disclosure.

A server apparatus 3 of the moving body management system 1 detects an electric scooter 2 that has been abandoned at a location that is not a predetermined location for a predetermined period of time or longer. In the following description, an electric scooter 2 that has been abandoned at a location that is not a predetermined location for a predetermined period of time or longer is called “abandoned electric scooter”, and reference “2A” is given thereto.

In this embodiment, the predetermined location includes a parking station TS and a lending station KS. The predetermined period is set to a period by which occurrence of an abandonment may be determined based on a test, a simulation and so on in advance. The predetermined period is 24 hours, for example.

The parking station TS is a location where the electric scooter 2 can be parked. An upper limit of the number of electric scooters 2 that can be parked is set for the parking station TS of this embodiment. It should be noted that the parking station TS may be a location where the moving body battery 23 of the electric scooter 2 can be charged.

The lending station KS is a location where lending of an electric scooter 2 is performed. In the lending station KS, the moving body battery 23 of the electric scooter 2 may be charged.

When the server apparatus 3 detects an abandoned electric scooter 2A, the server apparatus 3 detects a vehicle 4 that is approaching an abandonment area AR including a current position of the detected abandoned electric scooter 2A. The abandonment area AR is a circular area having a radius of, for example, 10 meters (m) about the current position of the abandoned electric scooter 2A. It should be noted that the shape and size of the abandonment area AR are not limited thereto.

A vehicle 4 to be detected by the server apparatus 3 includes a vehicle battery 6 being capable of charging the moving body battery 23 of the electric scooter 2. The vehicle battery 6 of this embodiment is a battery lent to a user P of the vehicle 4.

The vehicle battery 6 corresponds to a “second charging apparatus” of the present disclosure.

It should be noted that, according to this embodiment, a four-wheel private vehicle is exemplarily described as the vehicle 4, but the vehicle 4 may be a taxi, a vehicle used by a delivery company, or a bus, without limiting to a private vehicle. Further, the number of wheels of the vehicle 4 is not limited to four.

When the server apparatus 3 detects a vehicle 4 approaching an abandonment area AR, the server apparatus 3 transmits notification information J1 to a terminal apparatus 5 used by a user P of the detected vehicle 4. The notification information J1 includes information on a new location to which the abandoned electric scooter 2A is to be moved. The terminal apparatus 5 is, for example, a smartphone in which an application program relating to the electric scooter 2 is installed. Hereinafter, the application program is simply called an “app”, and reference numeral “511” is given thereto. With a function of the app 511, the terminal apparatus 5 receives the notification information J1 and performs a notification of a new location and so on based on the notification information J1.

If the user P of the vehicle 4 detected as approaching the abandonment area AR moves the abandoned electric scooter 2 to a new location, the server apparatus 3 calculates an incentive to be given to the user P. Then, the server apparatus 3 gives the calculated incentive to the user P. Although money is exemplarily described as the incentive according to this embodiment, the incentive may be, for example, a coupon or the like, without limiting to money.

Referring to FIG. 1, three vehicles 4 of vehicles 4A, 4B and 4C are shown. FIG. 1 shows a case where, on the way to a destination D1, a user P1 of the vehicle 4A has moved an abandoned electric scooter 2A positioned within an abandonment area AR1 to a parking station TS1. Further, FIG. 1 shows a case where, on the way to a destination D2, a user P2 of the vehicle 4B has moved an abandoned electric scooter 2A positioned within an abandonment area AR2 to a lending station KS1. Further, FIG. 1 shows a case where, on the way to a destination D3, a user P3 of the vehicle 4C has moved an abandoned electric scooter 2A positioned within an abandonment area AR3 to a parking station TS3 that is the closest to a requester Y who has issued a use request for the electric scooter 2. Referring to FIG. 1, it is supposed that an incentive is given to each of the users P1, P2 and P3. It should be noted that the requester Y issues the use request for the electric scooter 2 by operating a requester terminal 7 such as a smartphone. In the requester terminal 7, an application program for issuing a use request is installed.

The moving body management system 1 includes an electric scooter 2, a vehicle 4, and a terminal apparatus 5.

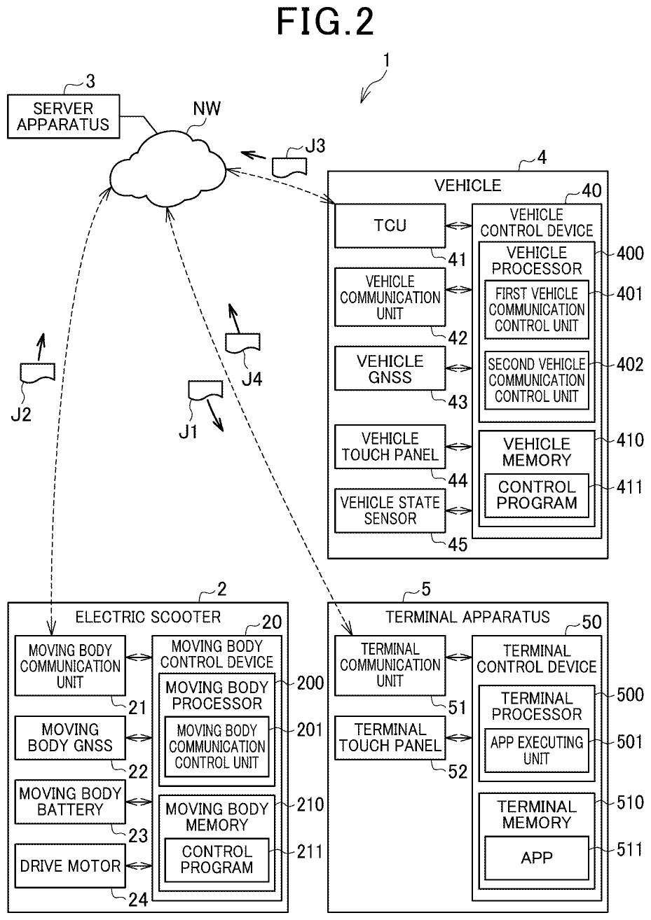

FIG. 2 is a diagram showing configurations of the electric scooter 2, the vehicle 4 and the terminal apparatus 5.

### [2. Configuration of Electric Scooter]

First, a configuration of the electric scooter 2 is described.

The electric scooter 2 includes a moving body control device 20, a moving body communication unit 21, a moving body global navigation satellite system (GNSS) 22, the moving body battery 23, and the drive motor 24.

The moving body control device 20 has a moving body processor 200 and a moving body memory 210 and controls each component of the electric scooter 2. The moving body processor 200 is a processor such as a central processing unit (CPU). By reading and executing a control program 211 stored in the moving body memory 210, the moving body processor 200 functions as a moving body communication control unit 201. The moving body memory 210 is a memory that stores a program and data. The moving body memory 210 stores the control program 211 and data to be processed by the moving body processor 200. The moving body memory 210 has a nonvolatile storage area. It should be noted that the moving body memory 210 may have a volatile storage area and may configure a work area for the moving body processor 200.

To the moving body control device 20, the moving body communication unit 21, the moving body GNSS 22, the moving body battery 23, and the drive motor 24 are connected. It should be noted that other apparatuses may be connected to the moving body control device 20. The moving body communication unit 21 has communication hardware relating to wireless such as an antenna and a wireless communication circuit. Over a communication network NW, the moving body communication unit 21 communicates with the server apparatus 3 connecting to the communication network NW. The communication network NW is only required to be a data communication network and is, for example, a wide area communication network including a public network.

The moving body GNSS 22 measures a current position of the electric scooter 2. The moving body GNSS 22 outputs information on the measured current position to the moving body control device 20.

The moving body battery 23 is a chargeable battery. The moving body battery 23 supplies power to each component of the electric scooter 2. The moving body battery 23 outputs information on an amount of charge to the moving body control device 20.

The drive motor 24 drives by receiving power supply from the moving body battery 23. The drive motor 24 rotates a wheel of the electric scooter 2 under control of the moving body control device 20.

As described above, the moving body processor 200 functions as the moving body communication control unit 201.

The moving body communication control unit 201 communicates with the server apparatus 3 through the moving body communication unit 21. The moving body communication control unit 201 generates first upload information J2 at predetermined cycles and transmits the generated first upload information J2 to the server apparatus 3. The first upload information J2 includes a moving body ID that is identification information of the electric scooter 2, information on a current position of the electric scooter 2 measured by the moving body GNSS 22, information on an amount of charge of the moving body battery 23 and so on.

It should be noted that the moving body ID is prestored in the moving body memory 210.

### [3. Configuration of Vehicle]

Next, a configuration of the vehicle 4 is described. The vehicle 4 includes a vehicle control device 40, a telematics control unit (TCU) 41 (computer), a vehicle communication unit 42, a vehicle GNSS 43, a vehicle touch panel 44, and a vehicle state sensor 45.

The vehicle control device 40 has a vehicle processor 400 and a vehicle memory 410 and controls each component of the vehicle 4. The vehicle processor 400 is a processor such as a CPU. By reading and executing a control program 411 stored in the vehicle memory 410, the vehicle processor 400 functions as a first vehicle communication control unit 401 and a second vehicle communication control unit 402. The vehicle memory 410 is a memory that stores a program and data. The vehicle memory 410 stores the control program 411 and data to be processed by the vehicle processor 400. The vehicle memory 410 has a nonvolatile storage area. It should be noted that the vehicle memory 410 may have a volatile storage area and may configure a work area for the vehicle processor 400.

To the vehicle control device 40, the TCU 41, the vehicle communication unit 42, the vehicle GNSS 43, the vehicle touch panel 44, and the vehicle state sensor 45 are connected. It should be noted that other apparatuses may be connected to the vehicle control device 40.

The vehicle communication unit 42 has a communication device such as a communication circuit. The vehicle communication unit 42 communicates with an apparatus such as a smartphone to be used by a passenger of the vehicle 4. The communication standard for the vehicle communication unit 42 may be a wireless communication standard or a wired communication standard.

The vehicle GNSS 43 measures a current position of the vehicle 4. In a case where a car navigation system, not shown, is mounted in the vehicle 4, a global positioning system (GPS) unit or the like included in the car navigation device may be used as the vehicle GNSS 43. The vehicle GNSS 43 outputs a measurement result to the vehicle control device 40.

The vehicle touch panel 44 is a touch panel. The vehicle touch panel 44 displays various kinds of information under control of the vehicle control device 40. Further, the vehicle touch panel 44 outputs a signal corresponding to a touch operation to the vehicle control device 40.

The vehicle state sensor 45 includes, for example, a triaxial acceleration sensor, a yaw rate sensor, and a speed sensor. The vehicle state sensor 45 outputs a detected value to the vehicle control device 40 at predetermined cycles.

As described above, the vehicle processor 400 functions as the first vehicle communication control unit 401 and the second vehicle communication control unit 402.

The first vehicle communication control unit 401 communicates with the server apparatus 3 through the TCU 41. The first vehicle communication control unit 401 generates second upload information J3 at predetermined cycles and transmits the generated second upload information J3 to the server apparatus 3. The second upload information J3 includes a vehicle ID that is identification information of the vehicle 4, information on a current position measured by the vehicle GNSS 43, information on a traveling direction of the vehicle 4, information on a destination of the vehicle 4, and so on. The vehicle ID is prestored in the vehicle memory 410. In order to generate the second upload information J3, the first vehicle communication control unit 401 requires a traveling direction of the vehicle 4 based on a current position measured by the vehicle GNSS 43 and a detected value by the vehicle state sensor 45. Further, the first vehicle communication control unit 401 includes information on a destination input through the vehicle touch panel 44 or the like in the second upload information J3.

Through the vehicle communication unit 42, the second vehicle communication control unit 402 communicates with an apparatus connecting to the vehicle communication unit 42.

### [4. Configuration of Terminal Apparatus]

Next, a configuration of the terminal apparatus 5 is described.

The terminal apparatus 5 includes a terminal control device 50, a terminal communication unit 51, and a terminal touch panel 52.

The terminal control device 50 has a terminal processor 500 and a terminal memory 510 and controls each component of the terminal apparatus 5. The terminal processor 500 is a processor such as a CPU. By reading and executing an app 511 stored in the terminal memory 510, the terminal processor 500 functions as an app executing unit 501. The terminal memory 510 is a memory that stores a program and data. The terminal memory 510 stores the app 511, a program excluding the app 511, and data to be processed by the terminal processor 500. The terminal memory 510 has a nonvolatile storage area. It should be noted that the terminal memory 510 may have a volatile storage area and may configure a work area for the terminal processor 500.

To the terminal control device 50, the terminal communication unit 51 and the terminal touch panel 52 are connected. It should be noted that other apparatuses may be connected to the terminal control device 50.

The terminal communication unit 51 has communication hardware such as an antenna and a wireless communication circuit.

The terminal communication unit 51 of this embodiment communicates with the server apparatus 3 over the communication network NW.

The terminal touch panel 52 is a touch panel. The terminal touch panel 52 displays various kinds of information under control of the terminal control device 50. Further, the terminal touch panel 52 outputs a signal corresponding to a touch operation to the terminal control device 50.

As described above, the terminal processor 500 functions as the app executing unit 501.

The app executing unit 501 communicates with the server apparatus 3 through the terminal communication unit 51. The app executing unit 501 causes the terminal touch panel 52 to display various kinds of information relating to the electric scooter 2. The app executing unit 501 receives various kinds of input through the terminal touch panel 52. The app executing unit 501 receives the notification information J1 from the server apparatus 3. In response to reception of an input that a movement of the electric scooter 2 has completed, the app executing unit 501 transmits movement completion information J4 indicating that the movement of the electric scooter 2 has completed to the server apparatus 3. The movement completion information J4 includes a user ID that is identification information of a user P. The user ID is prestored in the terminal memory 510.

### [5. Configuration of Server Apparatus]

The moving body management system 1 includes the server apparatus 3.

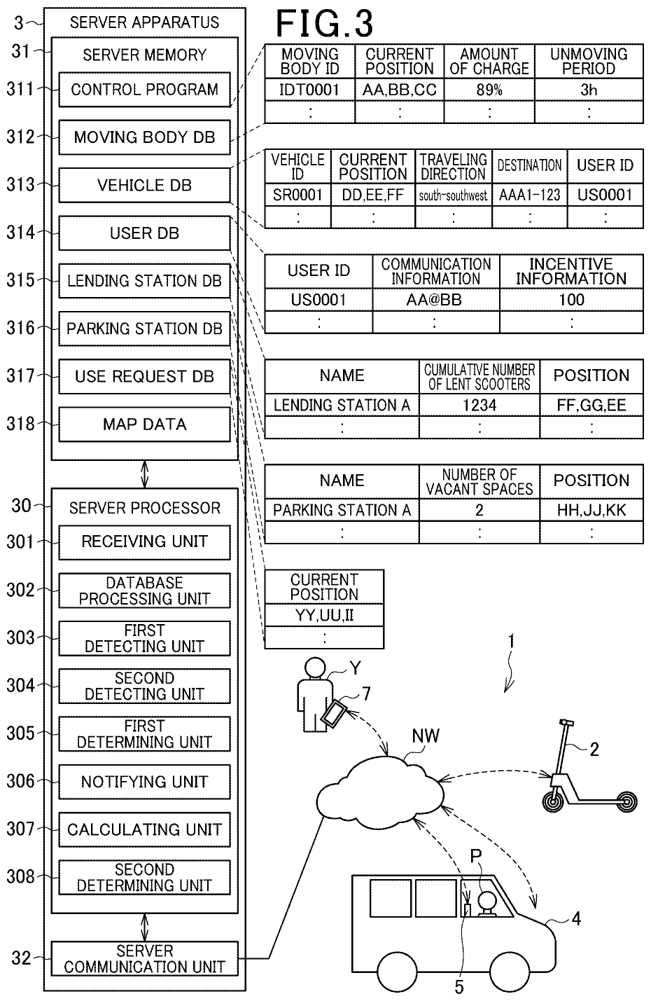

FIG. 3 is a diagram showing a configuration of the server apparatus 3.

The server apparatus 3 includes a server processor 30 that is a processor such as a CPU, a server memory 31 that is a memory storing a program and data, and a server communication unit 32.

By reading and executing a control program 311 stored in the server memory 31, the server processor 30 functions as a receiving unit 301, a database processing unit 302, a first detecting unit 303, a second detecting unit 304, a first determining unit 305, a notifying unit 306, a calculating unit 307 and a second determining unit 308.

The server memory 31 stores a program to be executed by the server processor 30 and data to be processed by the server processor 30. The server memory 31 stores the control program 311 to be executed by the server processor 30, a moving body database (DB) 312, a vehicle DB 313, a user DB 314, a lending station DB 315, a parking station DB 316, a use request DB 317, map data 318, and other various kinds of data. The server memory 31 has a nonvolatile storage area. Further, the server memory 31 may have a volatile storage area and may configure a work area for the server processor 30.

For each electric scooter 2, the moving body DB 312 stores a record having information on the electric scooter 2. Information on the electric scooter 2 included in one record includes a moving body ID, information on a current position of the electric scooter 2, information on an amount of charge of the moving body battery 23, and information on an unmoving period that is a period in which the position does not change.

For each vehicle 4, the vehicle DB 313 stores a record having information on the vehicle 4.

The information on the vehicle 4 included in one record includes a vehicle ID, information on a current position of the vehicle 4, information on a traveling direction of the vehicle 4, information on a destination of the vehicle 4, and a user ID. It should be noted that association between a vehicle ID and a user ID is properly performed in advance.

For each user P, the user DB 314 stores a record having information on the user P. Information on a user P included in one record includes a user ID, communication information for communicating with the terminal apparatus 5 used by the user P, and information on an incentive.

For each lending station KS, the lending station DB 315 stores a record having information on the lending station KS. The information on a lending station KS included in one record includes information on a name of the lending station KS, information on the cumulative number of lent scooters that is a cumulative value of the number of lent scooters, and information on a position of the lending station KS. Information on a lending station KS is properly updated when the number of lent scooters in the corresponding lending station KS increases.

For each parking station TS, the parking station DB 316 stores a record having information on the parking station TS. The information on a parking station TS included in one record includes information on a name of the parking station TS, information on the number of vacant spaces indicating the number of electric scooters 2 that can be parked, and information on a position of the parking station TS. The information on the parking station TS is properly updated when the number of vacant spaces is changed in the corresponding parking station TS.

For each use request for the electric scooter 2, the use request DB 317 stores a record having information on a current position of a requester Y.

The map data 318 is data storing road map information, facility information on various facilities and so on, data for map matching and so on. The road map information includes a road network representing roads on a map by using lines, and includes information on a link where a road is divided into a plurality of sections by handling intersections, branch points and so on as nodes and a part between nodes is defined as a link. The facility information indicates a position of a facility, a name of the facility and so on.

The server communication unit 32 includes communication hardware such as a communication circuit. Over the communication network NW, the server communication unit 32 communicates with an electric scooter 2, a vehicle 4, a terminal apparatus 5, and a requester terminal 7.

As described above, the server processor 30 functions as the receiving unit 301, the database processing unit 302, the first detecting unit 303, the second detecting unit 304, the first determining unit 305, the notifying unit 306, the calculating unit 307 and the second determining unit 308.

The receiving unit 301 communicates with the electric scooter 2, the vehicle 4, and the terminal apparatus 5 through the server communication unit 32. The receiving unit 301 receives the first upload information J2 from the electric scooter 2. The receiving unit 301 receives second upload information J3 from the vehicle 4.

The receiving unit 301 receives movement completion information J4 from the terminal apparatus 5. The receiving unit 301 receives use request information indicating a use request for the electric scooter 2 from the requester terminal 7. The use request information includes information on a current position of the requester terminal 7 as a current position of the requester Y.

The database processing unit 302 updates various databases stored in the server memory 31.

When the receiving unit 301 receives the first upload information J2, the database processing unit 302 updates the moving body DB 312. The database processing unit 302 handles a record including a moving body ID included in the received first upload information J2 as an update target. If the information on the current position included in the first upload information J2 and the information on the current position included in the record to be updated are different, the database processing unit 302 updates the information on the current position included in the record to be updated with the information on the current position included in the first upload information J2. If the information on the current position included in the first upload information J2 and the information on the current position of the record to be updated are matched, the database processing unit 302 acquires, as an unmoving period, the date and time period from a date and time when the information on the current position is updated last time to the present time and updates the information on the unmoving period included in the record to be updated with the acquired unmoving period.

When the receiving unit 301 receives the second upload information J3, the database processing unit 302 updates the vehicle DB 313. The database processing unit 302 handles a record including a vehicle ID included in the second upload information J3 as an update target. The database processing unit 302 updates each of information on a current position included in the record to be updated, information on a traveling direction and information on a destination with the information included in the second upload information J3.

After information on an incentive associated with a user ID is output from the calculating unit 307, which will be described below, the database processing unit 302 updates information on the incentive included in the record having the same user ID as the user ID output from the calculating unit 307 with information to which the incentive calculated by the calculating unit 307 is added. In this way, the database processing unit 302 functions as a giving unit that gives an incentive calculated by the calculating unit 307.

If the receiving unit 301 receives use request information from the requester terminal 7, the database processing unit 302 stores, in the use request DB 317, a record having information on a current position of the requester Y. The database processing unit 302 stores the information on the current position included in the use request information as one record in the use request DB 317.

The first detecting unit 303 detects an abandoned electric scooter 2. In more detail, the first detecting unit 303 detects an abandoned electric scooter 2A by referring to the moving body DB 312, the lending station DB 315 and the parking station DB 316 and identifying a record which indicates a current position that is not a predetermined location and has an unmoving period greater than or equal to a predetermined period from the moving body DB 312.

The second detecting unit 304 detects a vehicle 4 approaching an abandonment area AR including a current position of the abandoned electric scooter 2A detected by the first detecting unit 303. The vehicle 4 approaching the abandonment area AR is a vehicle 4 having a clearance from the abandonment area AR less than or equal to a predetermined distance (1 km, for example) and having a traveling direction toward the abandonment area AR. The second detecting unit 304 refers to the moving body DB 312 and the map data 318 and recognizes the position and size of the abandonment area AR including the current position of the abandoned electric scooter 2A detected by the first detecting unit 303. Next, the second detecting unit 304 refers to the vehicle DB 313 and detects a vehicle 4 having a clearance from the recognized abandonment area AR less than or equal to the predetermined distance and having a traveling direction toward the recognized abandonment area AR. More specifically, the second detecting unit 304 identifies, from the vehicle DB 313, a record indicating a current position at a clearance from the recognized abandonment area AR less than or equal to the predetermined distance and indicating a traveling direction toward the recognized abandonment area AR.

From a plurality of predetermined locations, the first determining unit 305 determines a new location to which the electric scooter 2 detected by the first detecting unit 303 is to be moved. When a new location is determined, the first determining unit 305 outputs information on the determined new location to the notifying unit 306. Operations of the first determining unit 305 are described below.

The notifying unit 306 notifies the new location determined by the first determining unit 305 to a user P of the vehicle 4 detected by the second detecting unit 304. More specifically, the notifying unit 306 refers to the vehicle DB 313 and the user DB 314 and transmits notification information J1 to the terminal apparatus 5 used by a user P of the vehicle 4 detected by the second detecting unit 304. The notification information J1 transmitted by the notifying unit 306 includes information on the new location determined by the first determining unit 305.

If the user P of the vehicle 4 detected by the second detecting unit 304 moves the electric scooter 2 detected by the first detecting unit 303 to the new location determined by the first determining unit 305, the calculating unit 307 calculates an incentive to be given to the user P of the vehicle 4. The calculating unit 307 may calculate an incentive such that its value depends on the kind of new location, for example. Further, the calculating unit 307 may calculate an incentive such that its value depends on the movement distance by which the electric scooter 2 has been moved, for example. After the calculating unit 307 calculates an incentive, the calculating unit 307 outputs information on the calculated incentive to the database processing unit 302. In outputting the information on the calculated incentive to the database processing unit 302, the calculating unit 307 associates a user ID of the user P to which the calculated incentive is to be given with the information on the calculated incentive.

The second determining unit 308 determines a position for setting up a predetermined location with reference to the moving body DB 312. Details of the second determining unit 308 are described below.

Next, operations of each component of the moving body management system 1 are described.

### [6. Operations of Moving Body Management System]

First, operations of the moving body management system 1 relating to the notification of a new location is described.

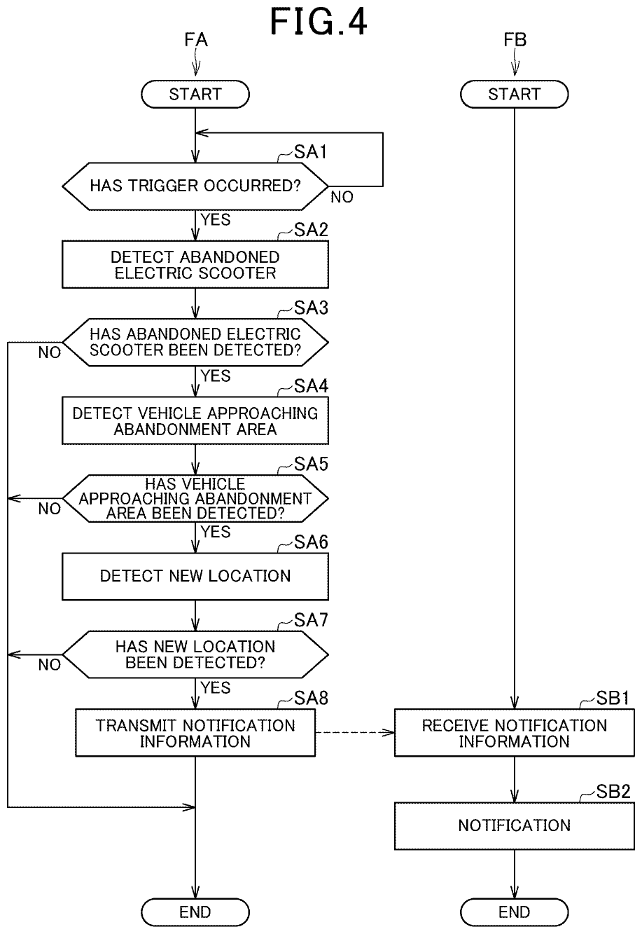

FIG. 4 is a flowchart showing operations of the moving body management system 1.

Referring to FIG. 4, a flowchart FA shows operations of the server apparatus 3, and a flowchart FB shows operations of the terminal apparatus 5.

As shown in the flowchart FA, the first detecting unit 303 in the server processor 30 determines whether a trigger for performing detection of an abandoned electric scooter 2A has occurred or not (step SA1). Examples of the trigger may include a fact that a predetermined cycle that is defined in advance has come, a fact that the moving body DB 312 has been updated, and so on.

If the first detecting unit 303 determines that the trigger for performing detection of an abandoned electric scooter 2A has not occurred (step SA1: NO), the first detecting unit 303 performs the determination in step SA1 again.

On the other hand, if the first detecting unit 303 determines that the trigger for performing detection of an abandoned electric scooter 2A has occurred (step SA1: YES), the first detecting unit 303 detects an abandoned electric scooter 2A with reference to the moving body DB 312 (step SA2).

The first detecting unit 303 determines whether an abandoned electric scooter 2A has been detected or not (step SA3).

If the first detecting unit 303 determines that an abandoned electric scooter 2A has not been detected (step SA3: NO), the server processor 30 ends this processing.

On the other hand, if the first detecting unit 303 determines that an abandoned electric scooter 2A has been detected (step SA3: YES), the second detecting unit 304 detects a vehicle 4 approaching an abandonment area AR with reference to the vehicle DB 313 (step SA4).

The second detecting unit 304 determines whether a vehicle 4 approaching the abandonment area AR has been detected or not (step SA5).

If the second detecting unit 304 determines that a vehicle 4 approaching the abandonment area AR has not been detected (step SA5: NO), the server processor 30 ends this processing.

On the other hand, if the second detecting unit 304 determines that a vehicle 4 approaching the abandonment area AR has been detected (step SA5: YES), the first determining unit 305 determines a new location (step SA6).

The determination of a new location by the first determining unit 305 is described in detail.

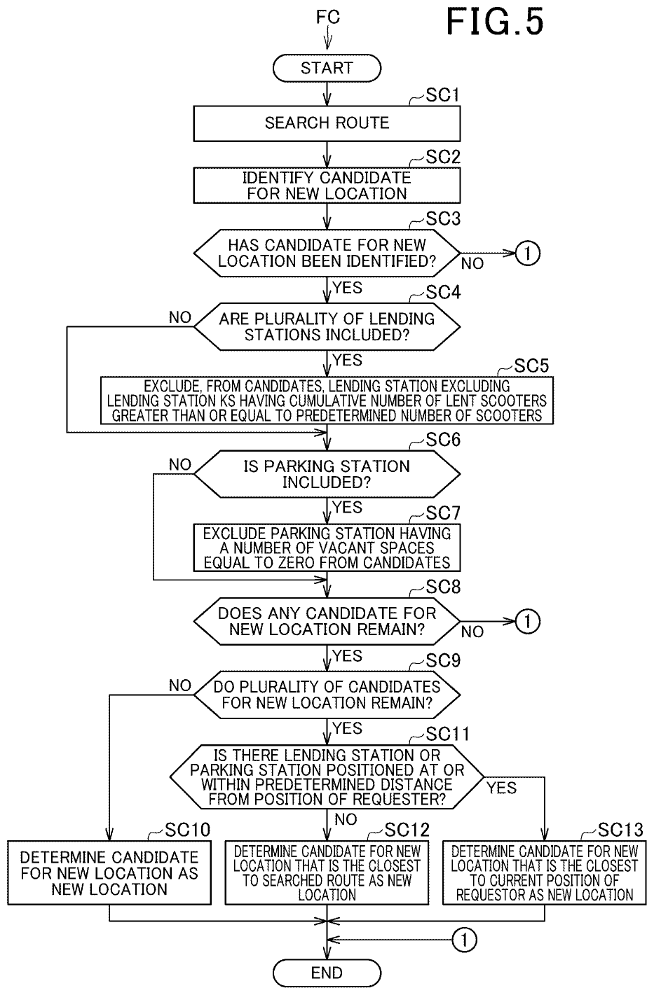

FIG. 5 is a flowchart FC showing operations of the first determining unit 305.

The first determining unit 305 refers to the vehicle DB 313 and the map data 318 and searches a route from a current position of a vehicle 4 detected by the second detecting unit 304 to a destination of the vehicle 4 (step SC1).

Next, the first determining unit 305 refers to the lending station DB 315 and the parking station DB 316 and identifies a lending station KS and a parking station TS positioned at or within a predetermined distance (500 m, for example) from the route searched in step SC1 as a candidate for a new location (step SC2).

The first determining unit 305 determines whether a candidate for a new location has been identified in step SC2 or not (step SC3).

If the first determining unit 305 determines that a candidate for a new location has not been identified in step SC2 (step SC3: NO), the first determining unit 305 ends the operation for determining a new location, without determining a new location.

On the other hand, if the first determining unit 305 determines that a candidate for a new location has been identified in step SC2 (step SC3: YES), the first determining unit 305 determines whether a plurality of lending stations KS is included in the new location identified in step SC2 or not (step SC4).

If the first determining unit 305 determines that a plurality of lending stations KS is included (step SC4: YES), the first determining unit 305 refers to the cumulative number of lent scooters in records stored in the lending station DB 315 and excludes, from candidates for a new location, a lending station KS that is not a lending station KS having a cumulative number of lent scooters greater than or equal to a predetermined number of scooters (step SC5). The predetermined number of scooters is properly determined based on a test, a simulation and so on in advance. The predetermined number of scooters is 200, for example.

On the other hand, if the first determining unit 305 determines that a plurality of lending stations KS is not included in the candidates for a new location identified in step SC2 (step SC4: NO), the processing in step SC5 is skipped.

The first determining unit 305 determines whether a parking station TS is included in the candidates for a new location or not (step SC6).

If the first determining unit 305 determines that a parking station TS is included in the candidates for a new location (step SC6: YES), the first determining unit 305 refers to information on the number of vacant spaces in records stored in the parking station DB 316 and excludes a parking station TS having a number of vacant spaces equal to zero from the candidates for a new location (step SC7).

On the other hand, if the first determining unit 305 determines that a parking station TS is not included in the candidates for a new location (step SC6: NO), the step SC7 is skipped.

The first determining unit 305 determines whether any candidate for a new location remains or not (step SC8).

If the first determining unit 305 determines that no candidate for a new location remains (step SC8: NO), the first determining unit 305 ends the operation for determining a new location, without determining a new location.

On the other hand, if the first determining unit 305 determines that a candidate for a new location remains (step SC8: YES), the first determining unit 305 determines whether a plurality of candidates for a new location remain or not (step SC9).

If the first determining unit 305 determines that a plurality of candidates for a new location do not remain (step SC9: NO), the first determining unit 305 determines the candidate for a new location as a new location (step SC10).

If the first determining unit 305 determines that a plurality of candidates for a new location remain (step SAC9: YES), the first determining unit 305 determines whether there is a lending station KS or a parking station TS positioned at or within a predetermined distance from the position of the requester Y in the candidates for a new location or not (step SC11).

If the first determining unit 305 determines that there is not a lending station KS or a parking station TS positioned at or within a predetermined distance from the position of the requester Y (step SC11: NO), the first determining unit 305 determines a candidate for a new location that is the closest to the route searched in step SC1 among the candidates for a new location as a new location (step SC12).

On the other hand, if the first determining unit 305 determines that there is a lending station KS or a parking station TS positioned at or within a predetermined distance from the position of the requester Y (step SC11: YES), the first determining unit 305 determines, as a new location, the lending station KS or parking station TS positioned at the closest position from the current position of the requester Y (step SC13).

Referring back to the flowchart FA in FIG. 4, the first determining unit 305 determines whether a new location has been determined or not (step SA7).

If the first determining unit 305 determines that a new location has not been determined (step SA7: NO), the server processor 30 ends this processing.

On the other hand, if the first determining unit 305 determines that a new location has been determined (step SA7: YES), the notifying unit 306 transmits notification information J1 to the terminal apparatus 5 (step SA8).

As shown in the flowchart FB, the app executing unit 501 in the terminal apparatus 5 receives the notification information J1 from the server apparatus 3 (step SB1).

Next, the app executing unit 501 performs notification relating to the abandoned electric scooter 2A based on the received notification information J1 (step SB2).

In step SB2, for example, the app executing unit 501 causes the terminal touch panel 52 to display a notification screen so that the notification relating to the abandoned electric scooter 2A is performed. This notification screen includes information on a position of the abandoned electric scooter 2A, a position of the new location and so on.

Next, operations of the moving body management system 1 are described in a case where an electric scooter 2 has been moved to a predetermined location.

With reference to FIG. 1, operations of the moving body management system 1 are specifically described.

Referring to FIG. 1, a vehicle 4A moving toward a destination D1 is shown. In the example in FIG. 1, with respect to the vehicle 4A, parking stations TS1 and TS2 are identified as candidates for a new location through the operations in FIG. 4. In the example in FIG. 1, the number of vacant spaces in the parking station TS2 is zero, and the number of vacant spaces in the parking station TS1 is one. Therefore, in the example in FIG. 1, the parking station TS1 is notified as a new location to a user P1 of the vehicle 4A.

Referring to FIG. 1, a vehicle 4B moving toward a destination D2 is shown. In the example in FIG. 1, with respect to the vehicle 4B, lending stations KS1 and KS2 are identified as candidates for a new location through the operations in FIG. 4. In the example in FIG. 1, the cumulative number of lent scooters in the lending station KS2 is less than a predetermined number of scooters, and the cumulative number of lent scooters in the lending station KS1 is greater than or equal to the predetermined number of scooters. Therefore, in the example in FIG. 1, the lending station KS1 is notified as a new location to a user P2 of the vehicle 4B.

Referring to FIG. 1, a vehicle 4C moving toward a destination D3 is shown. In the example in FIG. 1, with respect to the vehicle 4C, a lending station KS3 and a parking station TS3 are identified as candidates for a new location through the operations in FIG. 4. In the example in FIG. 1, the predetermined location that is the closest to the requester Y is the parking station TS3. Therefore, in the example in FIG. 1, the parking station TS3 is notified as a new location to a user P3 of the vehicle 4C.

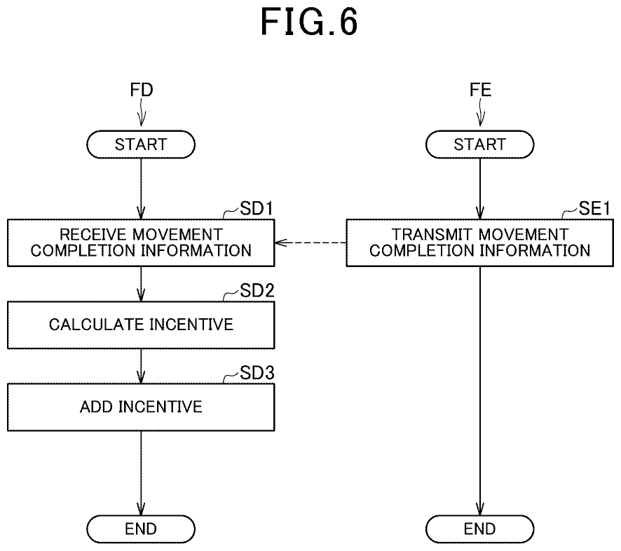

FIG. 6 is a flowchart showing operations of the moving body management system 1.

Referring to FIG. 6, a flowchart FD shows operations of the server apparatus 3, and a flowchart FE shows operations of the terminal apparatus 5.

In response to reception of an input that a movement of the electric scooter 2 has completed through the touch panel 52, the app executing unit 501 transmits movement completion information J4 to the server apparatus 3 (step SE1).

The receiving unit 301 in the server apparatus 3 receives the movement completion information J4 from the terminal apparatus 5 (step SD1).

Next, the calculating unit 307 in the server apparatus 3 calculates an incentive (step SD2). The calculating unit 307 outputs information on the calculated incentive in association with a user ID included in the movement completion information J4 received in step SD1 to the database processing unit 302.

Next, the database processing unit 302 adds the incentive calculated in step SD2 (step SD3).

### [8. Operations of Second Determining Unit]

Next, operations of the second determining unit 308 are described.

The second determining unit 308 determines whether a trigger for starting determination of a position of a predetermined location that is newly defined has occurred or not.

With reference to the information on the current position and the map data 318 in each of records stored in the moving body DB 312, the second determining unit 308 identifies an area in a predetermined range (such as a range having a diameter of 1 km, for example) in which a predetermined number (such as 20, for example) or more abandoned electric scooters 2 exist.

Next, the second determining unit 308 determines the inside of the identified area as a position of the predetermined location that is newly defined.

### [9. Other Embodiments]

According to another embodiment, if the first detecting unit 303 detects a plurality of abandoned electric scooters 2A, the second detecting unit 304 may detect a vehicle 4 one by one in accordance with predetermined priority levels for each of the abandoned electric scooters 2A. Here, an example of the predetermined priority levels is increasing order of the amount of charge. In a case of the example, the second detecting unit 304 identifies an amount of charge for each of the abandoned electric scooters 2A detected by the first detecting unit 303 with reference to the moving body DB 312. Next, based on the identified amounts of charge, the second detecting unit 304 determines the priority levels of the abandoned electric scooters 2A to be moved to a predetermined location. In other words, the second detecting unit 304 determines the priority levels of the abandoned electric scooters 2A to be moved to a predetermined location such that the priority level increases as the amount of charge decreases. Then, the second detecting unit 304 determines the vehicle 4 one by one for moving the abandoned electric scooters 2A in accordance with the determined priority levels.

The first determining unit 305 according to another embodiment may determine a new location by performing different operations from the operations in FIG. 5. For example, the first determining unit 305 according to another embodiment searches a route from the current position of a vehicle 4 detected by the second detecting unit 304 to a destination of the vehicle 4 and determines, as a new location, the lending station KS that is the closest to the searched route or the parking station TS that is the closest to the searched route and has a number of vacant spaces not equal to zero. Further, for example, the first determining unit 305 according to another embodiment searches a route from a current position of a vehicle 4 detected by the second detecting unit 304 to a destination of the vehicle 4, identifies one or more lending stations KS positioned at or within a predetermined distance (500 m, for example) from the searched route, and, if a plurality of lending stations KS is identified, determines, as a new location, the lending station KS having a cumulative number of lent scooters greater than or equal to a predetermined number of scooters. Further, for example, the first determining unit 305 according to another embodiment searches a route from a current position of a vehicle 4 detected by the second detecting unit 304 to a destination of the vehicle 4, identifies one or more of at least either lending station KS or parking station TS positioned at or within a predetermined distance (500 m, for example) from the searched route, and determines, as a new location, the lending station KS or parking station TS that is the closest to the position of the requester who has issued a use request for the electric scooter 2 from among the identified stations.

In the aforementioned embodiments, the lending station KS and the parking station TS are exemplarily described as the predetermined location. However, the predetermined location is not limited to the lending station KS and the parking station TS. The predetermined location may be either lending station KS or parking station TS. Further, the predetermined location may include another kind of location. For example, the predetermined location may include a maintenance factory where maintenance is performed on an electric scooter 2. In a case of the example, the moving body control device 20 of the electric scooter 2 performs a failure detection on the electric scooter 2 and, if it is detected that there is a failure, transmits the fact to the server apparatus 3. Then, in a case where a user P of the vehicle 4 moves, to a maintenance factory, the electric scooter 2 for which the fact that it is failed is transmitted, the moving body management system 1 calculates an incentive to be given to the user P higher than the incentive for a case where the electric scooter 2 is moved to a lending station KS or a parking station TS. Further, the predetermined location is not limited to a fixed location but may be a movable location such as a recovery vehicle, for example.

In the aforementioned embodiments, the first determining unit is configured to determine, as a new location, a parking station TS where the number of electric scooters 2 that can be parked is greater than or equal to one. However, the parking station TS determined as a new location is only required not to have a number of available spaces equal to zero for an electric scooter 2 and may only be required to have a number of available spaces greater than or equal to N for an electric scooters 2 (where N is an integer greater than or equal to one).

Although the electric scooter 2 is exemplarily described as the moving body of the present disclosure in the aforementioned embodiments, the moving body is not limited to the electric scooter 2. The moving body of the present disclosure may only be required to be one that is ridable and is movable by the vehicle 4.

In the aforementioned embodiments, the terminal apparatus 5 is configured to perform a notification relating to an abandoned electric scooter 2A. However, the notification relating to the abandoned electric scooter 2A may be performed by the vehicle 4. In a case of the configuration, the vehicle control device 40 receives the notification information J1 from the terminal apparatus 5 through the vehicle communication unit 42 and performs a notification based on the notification information J1. Further, in a case of the configuration, the vehicle control device 40 may transmit the movement completion information J4 to the server apparatus 3 through the TCU 41 or through the vehicle communication unit 42 and the terminal apparatus 5.

The server processor 30, the moving body processor 200, the vehicle processor 400, and the terminal processor 500 may be configured by a single processor or may be configured by a plurality of processors. The server processor 30, the moving body processor 200, the vehicle processor 400, and the terminal processor 500 may be hardware programmed to realize the corresponding functional units. In other words, the server processor 30, the moving body processor 200, the vehicle processor 400 and the terminal processor 500 may be configured by, for example, an application specific integrated circuit (ASIC) or a field programmable gate array (FPGA).

Further, each of the components of the electric scooter 2, the server apparatus 3, the vehicle 4 and the terminal apparatus 5 shown in FIGS. 2 and 3 are examples, and specific embodiments are not particularly limited. In other words, hardware individually corresponding to each of the components may not necessarily be implemented, but it is apparently possible to realize functions of each of the components by executing programs by one processor. Further, a part of the functions realized by software in the aforementioned embodiments may be hardware, or a part of the functions realized by hardware may be realized by software. Additionally, a specific detail configuration of each of other components of the electric scooter 2, the server apparatus 3, the vehicle 4 and the terminal apparatus 5 can be arbitrarily changed.

Further, for example, the units of steps of operations shown in FIGS. 4, 5 and 6 are divisions mainly based on processing details thereof for easy understanding of the operations, and the present invention is not limited by how the processing is divided into units and the names of the units. Based on processing details, the processing may be divided into much more step units. Further, one step unit may be divided so as to include much more processing. Further, the order of the steps may be changed properly without departing from the spirit and scope of the present invention.

### [10. Configurations Supported by the Aforementioned Embodiments]

The aforementioned embodiments support the following configurations.

(Configuration 1) A moving body management system comprising a first detecting unit that detects a ridable moving body that is abandoned for a predetermined period or longer at a location that is not a predetermined location, a second detecting unit that detects a vehicle approaching an abandonment area including a current position of the moving body detected by the first detecting unit based on information on the current position of the moving body detected by the first detecting unit, and a calculating unit that, if a user of the vehicle detected by the second detecting unit moves the moving body to the predetermined location, calculates an incentive to be given to the user of the vehicle detected by the second detecting unit.

According to the moving body management system of configuration 1, if a moving body that is abandoned for a predetermined period or longer at a location that is not a predetermined location is moved to a predetermined location, an incentive to be given to a user of a vehicle detected by the second detecting unit is calculated in the moving body management system. Thus, the incentive can be given to the user of the vehicle by moving the moving body that is abandoned for a predetermined period or longer at a location that is not the predetermined location to the predetermined location. Therefore, vehicle user's willingness to move an abandoned moving body to the predetermined location can be aroused so that the number of abandoned moving bodies can be effectively reduced.

(Configuration 2) The moving body management system according to configuration 1, further comprising a first determining unit that determines, from a plurality of the predetermined locations, a new location to which the moving body detected by the first detecting unit is to be moved, and a notifying unit that notifies the new location determined by the first determining unit to the user of the vehicle.

According to the moving body management system of configuration 2, since the user of the vehicle can grasp the new location to which a moving body that is abandoned for a predetermined period or longer at a location that is not the predetermined location is to be moved, the possibility that the user of the vehicle moves the abandoned moving body to the predetermined location can be increased. Therefore, the number of moving bodies that have been abandoned can be more effectively reduced.

(Configuration 3) The moving body management system according to configuration 2, wherein the first determining unit determines the new location based on a destination of the vehicle detected by the second detecting unit.

According to the moving body management system of configuration 3, the user of the vehicle can move the moving body to the new location on the way while the vehicle is traveling toward a destination. Therefore, since it can suppress the movement of the user of the vehicle away from the destination to move the moving body, reduction of a willingness to move an abandoned moving body to the predetermined location can be suppressed.

(Configuration 4) The moving body management system according to configuration 2 or 3, wherein the first determining unit determines, as the new location, a parking station where the number of the moving bodies that can be parked is greater than or equal to N (where N is an integer greater than or equal to 1).

According to the moving body management system of configuration 4, since a new location to which a moving body can be moved is notified, the possibility that the user of the vehicle can move the moving body can be increased so that the number of abandoned moving bodies can be more effectively reduced.

(Configuration 5) The moving body management system according to any one of configurations 2 to 4, wherein the first determining unit determines, as the new location, a lending station where the number of the lent moving bodies is greater than or equal to a predetermined number.

According to the moving body management system of configuration 5, since a moving body can be moved to a lending station where the number of the lent moving bodies is greater than or equal to a predetermined number, lending of moving bodies can be effectively supported.

(Configuration 6) The moving body management system according to any one of configurations 2 to 5, wherein if there is a requester who has issued a use request for the moving body, the first determining unit determines, as the new location, the predetermined location that is the closest to a position of the requester.

According to the moving body management system of configuration 6, the possibility that the requester can use a moving body quickly can be increased so that the requester's convenience can be enhanced.

(Configuration 7) The moving body management system according to any one of configurations 1 to 6, wherein the moving body includes a first charging apparatus that is a driving source, and the second detecting unit, if the first detecting unit detects a plurality of the moving bodies, determines priority levels of the moving bodies for moving to the predetermined location based on a charged state of the first charging apparatus of the moving body detected by the first detecting unit and detects the vehicle in accordance with the determined priority levels.

According to the moving body management system of configuration 7, a moving body having a lower amount of charge can be moved to the predetermined location by priority. Therefore, prompt charging is possible to a moving body that has a lower amount of charge and has been abandoned. Further, before detecting a moving body that is abandoned due to a low amount of charge is no longer possible, the moving body can be moved to the predetermined location. Therefore, the number of moving bodies that have been abandoned can be effectively reduced.

(Configuration 8) The moving body management system according to any one of configurations 1 to 7, wherein the moving body includes a first charging apparatus that is a driving source, and the second detecting unit detects the vehicle including a second charging apparatus that can charge the first charging apparatus.

According to the moving body management system of configuration 8, since a moving body can be charged while the user of the vehicle is moving the moving body, the moving body moved to the new location can be got ready to use.

(Configuration 9) The moving body management system according to any one of configurations 1 to 8, further comprising a second determining unit that determines a position of the predetermined location to be newly set up based on a current position of the moving body detected by the first detecting unit.

According to the moving body management system of configuration 9, the predetermined location can be set up in an area having many moving bodies that are abandoned for a predetermined period or longer at a location that is not the predetermined location so that the number of abandoned moving bodies can be more effectively reduced.

(Configuration 10) A control method for a moving body management system, the method including detecting a ridable moving body that is abandoned for a predetermined period or longer at a location that is not a predetermined location, detecting a vehicle approaching an abandonment area including a current position of the detected moving body based on information on the current position of the detected moving body, and if a user of the detected vehicle moves the moving body to the predetermined location, calculating an incentive to be given to the user of the detected vehicle.

According to the control method for a moving body management system of configuration 10, similar operational effects to those of the moving body management system can be attained.

### REFERENCE SIGNS LIST

1: moving body management system, 2: electric scooter(moving body), 3: server apparatus, 4, 4A, 4B, 4C: vehicle, 5: terminal apparatus, 6: vehicle battery (second charging apparatus), 23: moving body battery (first charging apparatus), 30: server processor, 31: server memory, 32: server communication unit, 301: receiving unit, 302: database processing unit, 303: first detecting unit, 304: second detecting unit, 305: first determining unit, 306: notifying unit, 307: calculating unit, 308: second determining unit, 311: control program, 312: moving body DB, 313: vehicle, 314: user DB, 315: lending station DB, 316: parking station DB, 317: use request DB, 318: map data, AR, AR1, AR2, AR3: abandonment area, KS, KS1, KS2, KS3: lending station, NW: communication network, P, P1, P2, P3: user, TS, TS1, TS2, TS3: parking station, Y: requester

What is claimed is:

1. A moving body management system comprising:
a first detecting unit that detects a ridable moving body that is abandoned for a predetermined period or longer at a location that is not a predetermined location;
a second detecting unit that detects a vehicle approaching an abandonment area including a current position of the moving body detected by the first detecting unit based on information on the current position of the moving body detected by the first detecting unit; and
a calculating unit that, if a user of the vehicle detected by the second detecting unit moves the moving body to the predetermined location, calculates an incentive to be given to the user of the vehicle detected by the second detecting unit.

2. The moving body management system according to claim 1, further comprising:
a first determining unit that determines, from a plurality of the predetermined locations, a new location to which the moving body detected by the first detecting unit is to be moved; and
a notifying unit that notifies the new location determined by the first determining unit to the user of the vehicle.

3. The moving body management system according to claim 2, wherein
the first determining unit
determines the new location based on a destination of the vehicle detected by the second detecting unit.

4. The moving body management system according to claim 2, wherein the first determining unit determines, as the new location, a parking station where the number of the moving bodies that can be parked is greater than or equal to N (where N is an integer greater than or equal to 1).

5. The moving body management system according to claim 2, wherein the first determining unit determines, as the new location, a lending station where the number of the lent moving bodies is greater than or equal to a predetermined number.

6. The moving body management system according to claim 2, wherein, if there is a requester who has issued a use request for the moving body, the first determining unit determines, as the new location, the predetermined location that is the closest to a position of the requester.

7. The moving body management system according to claim 1, wherein
the moving body includes a first charging apparatus that is a driving source, and
the second detecting unit,
if the first detecting unit detects a plurality of the moving bodies, determines priority levels of the moving bodies for moving to the predetermined location based on a charged state of the first charging apparatus of the moving body detected by the first detecting unit and
detects the vehicle in accordance with the determined priority levels.

8. The moving body management system according to claim 1, wherein
the moving body includes a first charging apparatus that is a driving source, and
the second detecting unit
detects the vehicle including a second charging apparatus that can charge the first charging apparatus.

9. The moving body management system according to claim 1, further comprising:
a second determining unit that determines a position for newly setting up the predetermined location based on the current position of the moving body detected by the first detecting unit.

10. A control method for a moving body management system, the method comprising:
detecting a ridable moving body that is abandoned for a predetermined period or longer at a location that is not a predetermined location;
detecting a vehicle approaching an abandonment area including a current position of the detected moving body based on information on the current position of the detected moving body; and
if a user of the detected vehicle moves the moving body to the predetermined location, calculating an incentive to be given to the user of the detected vehicle.
